(19) United States
(12) Patent Application Publication
(10) Pub. No.: US 2010/0174389 A1
(43) Pub. Date: Jul. 8, 2010

(54) AUTOMATIC AUDIO SOURCE SEPARATION WITH JOINT SPECTRAL SHAPE, EXPANSION COEFFICIENTS AND MUSICAL STATE ESTIMATION

(75) Inventors: Raphael Blouet, St Ouen (FR); Si Mohamed Aziz Sbai, Fontenay aux roses (FR); Antoine Liutkus, Paris (FR)

Correspondence Address: Mist Technologies SA, 204, rue de Crimee, Paris, 75019, FR

(73) Assignee: AUDIONAMIX, NEW YORK, NY (US)

(21) Appl. No.: 12/349,494

(22) Filed: Jan. 6, 2009

(51) Int. Cl. G06F 17/00; G06N 5/02

(52) U.S. Cl. 700/94; 706/52

(57) ABSTRACT

A method is provided that comprises segmenting an audio source file; optimizing a model based upon probability; and separating the audio source file.

### CROSS-REFERENCE TO OTHER APPLICATIONS

The following applications of common assignee and filed on the same day herewith are related to the present application, and are herein incorporated by reference in their entireties:

U.S. patent application Ser. No. ______ with attorney docket number MIST-002.

### FIELD OF THE INVENTION

This invention relates to an apparatus and methods for digital sound engineering, more specifically this invention relates to an apparatus and methods for Automatic Audio Source Separation with joint Spectral Shape, Expansion Coefficients and Musical state estimation.

### BACKGROUND

Non-negative matrix factorization (NMF) is a known method that allows unsupervised source separation. For example, NMF was introduced by Paatero and Tapper. See “Positive matrix factorization: a nonnegative factor model with optimal utilization of error estimates of data values”, Environmetrics, vol. 5, no. 2, pp. 111-126, 1994, hereinafter referred to merely as Paatero and Tapper and hereby incorporated herein by reference.

NMF was popularized by the simple multiplicative update rules of Lee and Seung. See D. D. Lee and H. S. Seung, “Algorithms for nonnegative matrix factorization”, in Advances in Neural Information Processing Systems 13, pp. 556-562, Denver, Colo., USA, 2000, hereinafter referred to merely as Lee and Seung and hereby incorporated herein by reference.

NMF has found a variety of real world applications in the areas such as pattern recognition see D. D. Lee and H. S. Seung, “Learning the parts of objects by nonnegative matrix factorization”, Nature, vol. 401, no. 6755, pp. 788-791, 1999, hereinafter referred to merely as Lee and Seung II and hereby incorporated herein by reference. NMF is also found in other real world applications as in blind source separation, see A. Cichocki, R. Zdunek, and S. Amari, “New algorithms for nonnegative matrix factorization in applications to blind source separation”, 2006 IEEE International Conference on Acoustics, Speech, and Signal Processing, ICASSP2006, Toulouse, France, 2006, hereinafter referred to merely as Zdunek and Amari and hereby incorporated herein by reference.

When applied on an audio signal, NMF system allows the split of a mixture of complex audio components into many elementary components. Complex audio component refers to an audio class such as musical instruments. Elementary audio component refers to lower level audio class such as musical note. When applied on the short term magnitude spectrum (STMS) or on the short term power spectrum (STPS) of audio data, NMF allows the factorization of the observed time sequence of STPS or STMS within a basis matrix (W) and an activation matrix H.

W is a D*K matrix. Each column of W is associated to the spectral shape of one of the elementary sources that compose the mixture. D is the number of frequency bins obtained after the spectral analysis and K is the number of elementary source. Each column w_k of W corresponds to the spectral shape of the elementary audio source s_k

H is a K*T matrix, where T is the number of STMS or STPS extracted from the audio file. Each element H(k,t) of H corresponds to the activation coefficient (expansion coefficients) source k at time t.

Source separation systems that are using NMF currently work on the whole audio file. They do not take in account the orchestration and/or timbre intra-variability of the audio file. It causes W to be very difficult to estimate.

In order, to recover separated audio track at a musical instrument level, there is a need for an apparatus and methods for Automatic Audio Source Separation with joint Spectral Shapes, Expansion Coefficients and Musical state estimation. In this case we define a multi-sate modeling of the audio file, each state is automatically associated to one orchestration (with homogeneous active instruments), and each state emission probability is driven by its own W and H. In the preferred implementation, the multi-state model is supposed to follow a Hidden Markov Model (HMM). The Hidden Markov Model has a finite set of states, each of which is associated with a (generally multidimensional) probability distribution also called state emission probability. Transitions among the states are governed by a set of probabilities called transition probabilities. In a particular state an outcome or observation can be generated, according to the associated probability distribution.

Therefore, there is a need for a novel apparatus and methods for Automatic Audio Source Separation with joint Spectral Shape, Expansion Coefficients and Musical state estimation.

### SUMMARY OF THE INVENTION

There is provided a novel apparatus and methods for Automatic Audio Source Separation with joint Spectral Shape, Expansion Coefficients and Musical state estimation.

There is provided a novel automatic method to segment an audio source file; optimize a model based upon likelihood maximisation of the segmentation, the set of elementary sources and the expansion coefficients.

A method is provided that comprises segmenting an audio source file; optimizing a segmental Non Negative Matrix Factorization model based upon probabilistic modeling of the audio mixture ; and separating the audio source file.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an example of a source separation system in accordance with the present invention.

FIG. 2 is a detailed depiction of FIG. 1. PSEUDO not PSUEDO

FIG. 3 is an example of a source separation system with filter bank analysis and synthesis.

FIG. 4 is an example of a source separation system in accordance with the invention with defined R homogeneous regions.

FIG. 5 is an implementation of the invention according to step 4.

FIG. 6 is a first example of a segmentation system.

FIG. 7 is a second example of a segmentation system.

FIG. 8 is a third example of a segmentation system.

FIG. 9 is a first example of a flowchart in accordance with the present invention.

FIG. 9A is a second example of a flowchart in accordance with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to signal processing. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

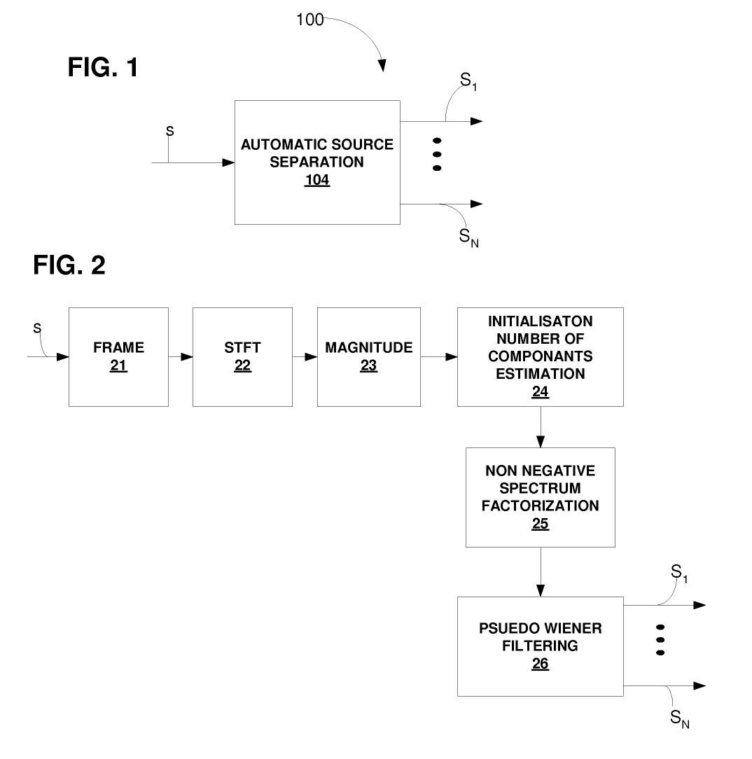

Referring to FIG. 1, a source separation system 100 is shown. A data source S such as audio data source is input into an automatic source separation block 104, wherein source S is separated into N separate sub-sources S₁,S₂, . . . , S_{N} with N being a positive integer. System 100 shows the automatic source separation system. Note that an automatic gathering strategy can be applied after the estimation of separated sources in MIST-001, which is hereby incorporated herein by reference.

As can be appreciated, NMF allows intuitive part-based decomposition of positive observation. Algorithms for NMF were first proposed by Lee and Seung “Algorithms for Nonnegative Matrix Factorization”, in Advances in Neural Information Processing Systems, 2001 which is hereby incorporated herein by reference; and applied to image classification. Since magnitude spectrum of an audio file can be seen as an image with nonnegative superposition of several components, NMF can be applied for music classification and recognition as well. In J. Paulus, T. Virtanen, “Drum Transcription with Nonnegative Spectrogram Factorisation”, in proceedings of the 13th EUSIPCO conference, Antalya, Turkey, September 2005 which is hereby incorporated herein by reference; Virtanen take advantage of NMF for sound source separation, estimating the belonging of the components to a characterized source and resynthesizing them.

Basically, NMF factorizes a nonnegative matrix V into two nonnegative matrices W and H seeking to minimize a specific cost function C. W is the basis matrix and H the encoding or weighted matrix, we hence have:

$$W , H = arg {min}_{w , h \geq 0} C ( V , WH ) \qquad equ . 1$$

NMF being not unique, appropriate additional features can lead to different solution with different properties of the representation. The properties include, for example, sparseness, smoothness. Moreover as the optimization algorithm is iterative, initialization of the process is crucial. Most known initializations use simple initializations for W and H, namely random positive matrices. However, random initialization does not generally provide a good first or initial estimate. Boutsidis and Gallopoulos C. Boutsidis and E Gallopoulos, in “SVD based initialization: a head start for Nonnegative Matrix Factorization”, Pattern Recognition, 2008 which is hereby incorporated herein by reference, described a Singular Value Decomposition (SVD) based initialization, the Nonnegative Double Singular Value Decomposition (NNDSVD). They show that NNDSVD is well suited to initialize NMF with sparse factors, leads to rapid reduction of the approximation error and provides fast alternatives and better results than random and centroid methods. Indeed, NNDSVD speeds up the convergence of the NMF algorithm, and leads to an optimal solution that is to say less redundancy, better sparseness and more localized parts within the extracted components. Weaknesses of the NNSVD come with its computational complexity and the amount of memory it requires. Moreover this approach works globally i.e on the whole audio recording. As audio components are not always active in a recording, it appears as suboptimal to estimate one unique basis matrix W for the whole recording.

The present invention presents a source separation strategy in which an audio recording is considered as : first, being composed of several homogeneous state, second, various states are linked between each other with state transition probability, and third, magnitude spectrum observations X(:), at time t and given state s and associated Ws and Hs, follows a Gaussian process as follows:

$$X ( \text{:} ) \sim N ( 0 , {\sum }_{k}^{K} {W}_{S} ( k , t ) {H}_{S} ( k , \text{:} ) )$$

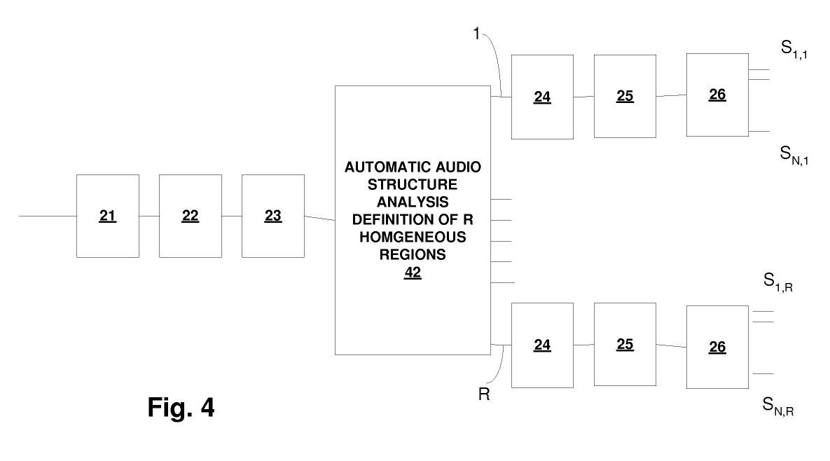

FIG. 4 shows automatic source separation system 400 as implemented by the instant invention. Note that an automatic gathering strategy can be applied after the estimation of separated sources MIST-001

An audio frame is extracted from the Source S every 25 ms by frame extraction block 21. The output of frame extraction block 21 in turn is subjected to Short Term Fourier Transform block 22 (STFT). The output of block 22 in turn is subjected to magnitude (absolute value) or power (square absolute value) in block 23. The output of block 23 in turn is subjected to the estimation of the optimal split of the acoustic space in R regions. Optimality is given by maximizing the likelihood of all states Non Negative Factorization parameters W_i and H_i. STMS or STPS vectors in each state are subjected to the estimation of the number of components estimation in block 24. State-by-state output of block 24 in turn is subjected to non-negative spectrum factorization in block 25 and new state sequence estimation. Blocks 24, 25 and new state sequence estimation are run until convergence of the mixture likelihood is achieved. The output of block 25 for each state in turn is subjected to pseudo-Wiener filtering in block 26. The filtered data if output as N separate sub-sources S₁,S₂, . . . , S_{N} with N being a positive integer.

An alternate implementation suggests to gather each W_i and to apply block 26 on a unique W.

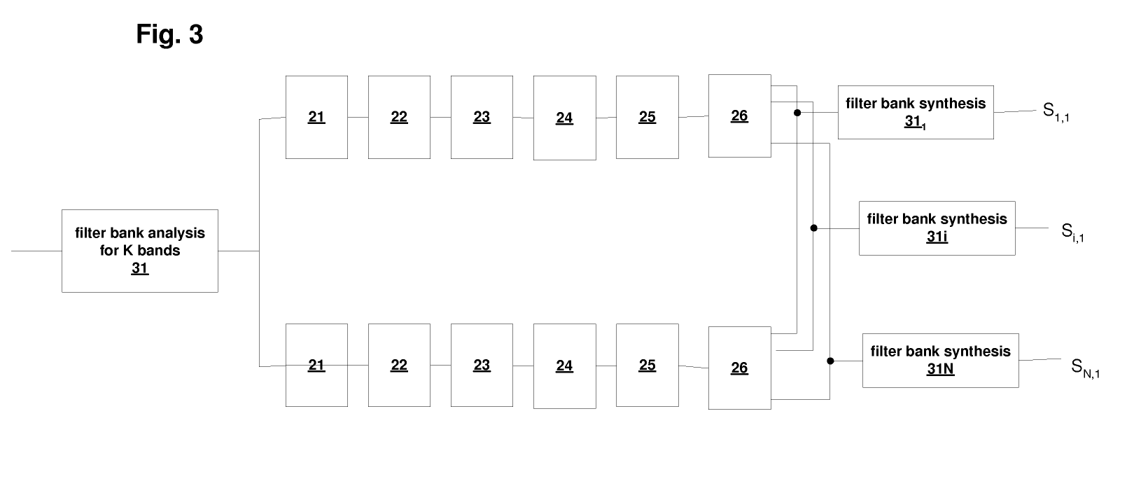

Referring to FIG. 3, an alternative embodiment of a source separation system with filter bank analysis and synthesis is shown. FIG. 3 is suitable as an alternative embodiment for a source S spanning k frequency bands, In other words, for some implementations, post-process the audio data by an analysis filter bank is desirable. This splits the audio file in M sub-bands. Each track is processed by the sequence of blocks frame extraction blocks 21-22-23-24-25-25. The complete track is then obtained by inputting the M tracks in (32) the filter bank synthesis system. As can be seen, this is made for the N tracks.

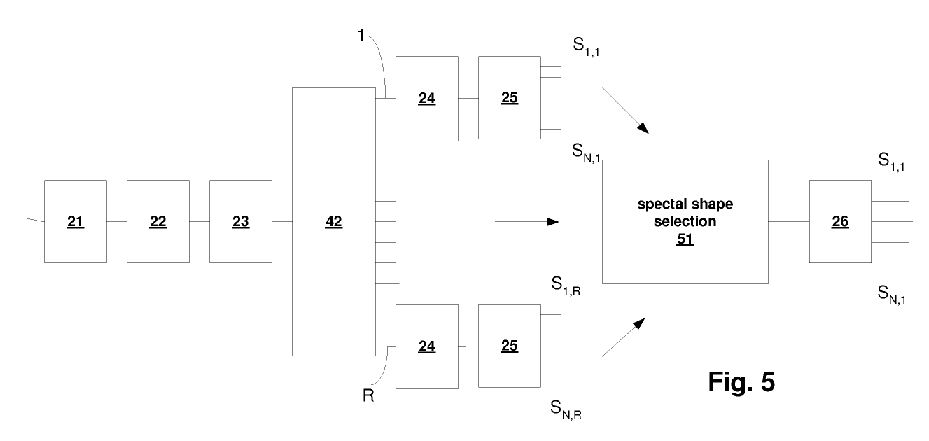

The source separation of the invention is described on FIG. 4. It defines a source separation system with defined R homogeneous regions is shown. The input signal S is analysed to obtain R homogeneous regions. Homogeneity is defined by the acoustic properties of the data. Separate tracks are estimated in each region by applying blocks 24-25-26 to the data in each region. Block 42 allows to obtain the R homogeneous region and to affect an observation to one region. Then we estimate the separated sources in each region. For simplicity, FIG. 4 can be replaced by FIG. 5.

Referring to FIG. 5, a simplified depiction of FIG. 4 is shown. the same than FIG. 4.with the difference that a spectral shape selection is performed by block 51 before applying the pseudo wiener filtering of block 26.

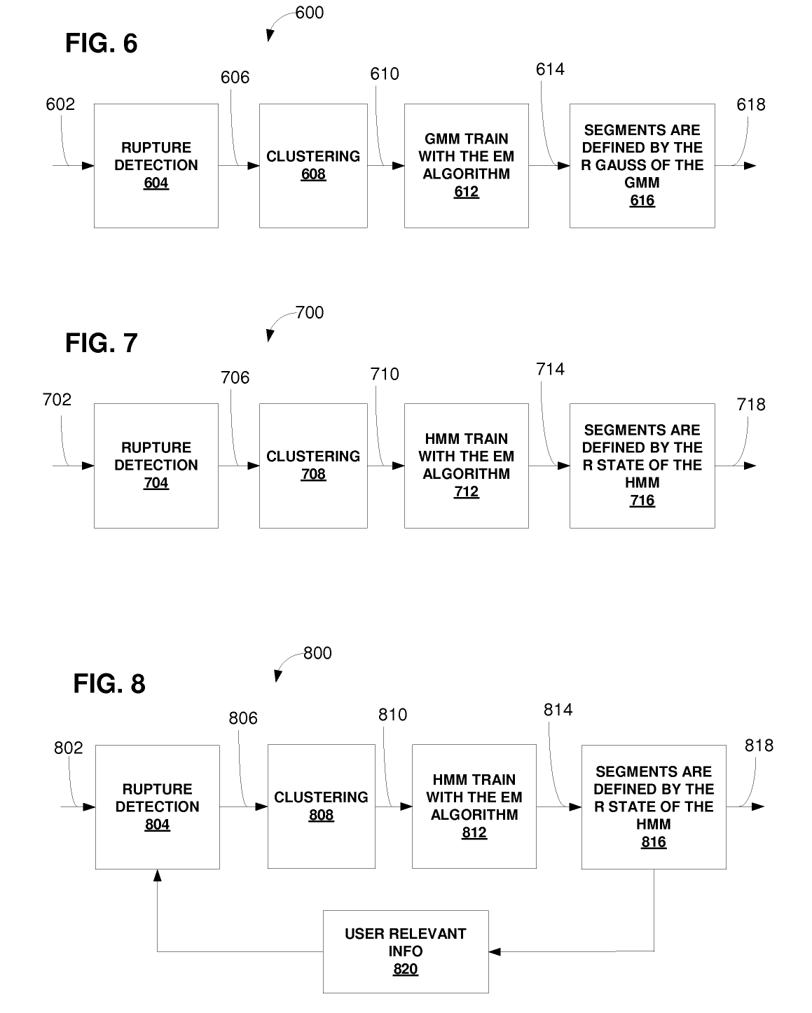

FIGS. 6 and 7 correspond to automatic unsupervised clustering systems.

Referring to FIG. 6, a first example 600 of a segmentation system is shown. Input 602 is subjected to a rupture detection block 604. The detected data 606 is further subjected to clustering 608 in clustering block 608. The clustered data 610, in turn, is subjected Gaussian Mixture Model (GMM) with R Gaussian components. A GMM is a linear sum of Gaussian components. The GMM is trained with the Expectation Maximization (EM) algorithm in block 612. The trained data is further subjected to block 616 wherein segments are defined by the R Gaussians densities of the GMM. R is the number of the Gaussian components used to define the Gaussian Mixture Model.

FIGS. 6 and 7 correspond to automatic unsupervised clustering systems.

Referring to FIG. 7, a second example 700 of a segmentation system is shown. Input 702 is subjected to a rupture detection block 704. The detected data 706 is further subjected to clustering 708 in clustering block 708. The clustered data 710, in turn, is subjected Hidden Markov Model (HMM) train with an EM algorithm in block 712. The trained data is further subjected to block 716 wherein segments are defined by the R states of the HMM. HMM is a statistical modeling technique that involves a finite number of states, here R defines the number of state.

Referring to FIG. 8, a third example 700 of a segmentation system is shown. Input 802 is subjected to a rupture detection block 804. The detected data 806 is further subjected to clustering 808 in clustering block 808. The clustered data 810, in turn, is subjected HMM train with an EM algorithm in block 812. The trained data is further subjected to block 816 wherein segments are defined by the R state of the HMM. In addition, the user relevant information obtained within block 818 is fed back into block 804.

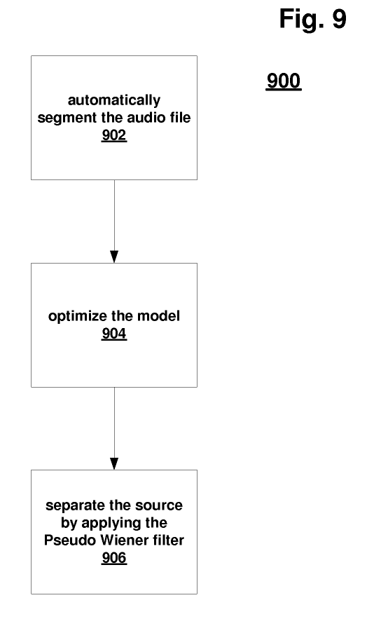

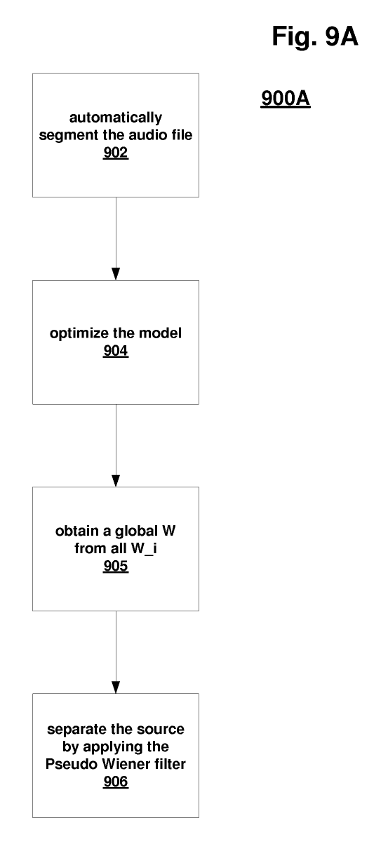

Referring to FIG. 9, a flowchart 900 of the present invention is shown. A step to automatically segment the audio file is performed initially (Step 902). Step 902 or this first segmentation step is used to initialize an optimization algorithm. Step 902 or this step can be made for instance with a Vector Quantization procedure.

A step to optimize the model based upon probability i.e. finding the best state sequence and the best (W_i, H_i) in each state i is performed (Step 904). Step 904 is made by busing the Expectation Maximization algorithm and the Viterbi backward/forward equations. Each state likelihood is given assuming a Normal distribution with a zero mean and a diagonal covariance matrix given by or according to the following:

p(x(t,:)|W_{—}iH_{—}i(:,t))=N(0,Σ_{—}k W_{—}i(:,k)*H_{—}i(k,t)) (eq. 2)

A step to separate the source by applying the Pseudo Wiener filter given the state sequence and the W_i,H_i is performed (Step 906).

Referring to FIG. 9A, in an alternate implementation 900A, in addition to all the steps of FIG. 9, step 906 is preceded by a gathering step (Step 905) that allows the system or process to obtain a global W from all W_i. We then estimate the global H necessary to build the pseudo wiener filter and to separate the source. Note that in this case the global W is different with the W that we would have estimated by applying NMF on the whole audio file.

The invention proposes a method and apparatus for jointly estimate three entities. The first entity comprises (a) the number, (b) the initial state probability, and (c) the transition probability between states. The second entity comprises the Wₛ and Hₛ, associated with each state. The third entity comprises the separated audio track given or limited by the optimal state sequence and the optimal Wₛ and Hₛ.

Furthermore, the automatic source separation method of the present invention includes a first automatic segmentation step (Step 902) that can be made for instance using F. Desobry, M. Davy, and C. Doncarli, “An online kernel change detection algorithm”, IEEE Transactions on Signal Processing, Volume 53, Issue 8, August 2005 Page(s): 2961-2974, which is hereby incorporated herein by reference.

Alternatively, the first automatic segmentation step may be achieved using GMM based rupture detection. The number of state can be fixed or determined by such methods as the Bayesian Information Criterion acronym (BIC) criterion.

This segmentation step allows the use of several NMF kernel at the same time or simultaneously, with all them having lower complexity and being more accurate as well as having a unique NMF kennel.

Furthermore, the method of the present invention includes a second step (Step 904) including an estimation of the optimal state sequence and of each Wₛ and Hₛ associated to each state. The best Non Negative Decomposition of associated observed spectrum may be achieved using for instance the algorithm describe in D. Lee, H. S. Seung, “Algorithms for Nonnegative Matrix Factorization”, in Advances in Neural Information Processing Systems, 2001 which is hereby incorporated herein by reference.

In addition, the method of the present invention iteratively estimate the optimal state sequence using the EM algorithm as described in A. Dempster, N. Laird, and D. Rubin. “Maximum likelihood from incomplete data via the EM algorithm”, Journal of the Royal Statistical Society, Series B, 39 (1):1-38, 1977 which is hereby incorporated herein by reference.

Still further, the method of the present invention wherein each state density observation is characterized by a Gaussian process, in which parameters are given by Wₛ and Hₛ associated to this state. Hence given each state, observation at time t follows equation 2:

Classical Source separation systems work in two stages. The first stage comprises defining a spectral shapes dictionary for each target source. This can be done thanks to a prior training phase or by applying Non-negative source separation on the observed spectra. the second stage comprises factorizing the mixture spectrogram on the dictionary and hence to set up the adapted Wiener Filter.

One of the advantages of the present invention is to perform prior segmentation of the audio mixture in order to simplify the estimation task (for both phase or stage 1 and 2) and to jointly estimate the acoustic region and the separation parameters.

Furthermore, for the method of present invention, the mixture likelihood derived from the source is driven by a multi-state probabilistic model. For each state, probabilistic densiy is driven by a Gaussian process. In other words, each state probabilistic density is a Gaussian distribution, observation at time t according to equation 2.

Some of the embodiments are described herein as a method or combination of elements of a method that can be implemented by a processor of a computer system or by other means of carrying out the function of the present invention. Thus, a processor with the necessary instructions for carrying out such a method or element of a method forms a means for carrying out the method or element of a method associated with the present invention. Furthermore, an element described herein of an apparatus embodiment is an example of a means for carrying out the function performed by the element for the purpose of carrying out the invention. It will be understood that the steps of methods discussed are performed in one embodiment by an appropriate processor (or processors) of a processing (i.e., computer) system executing instructions stored in a storage. The term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors. It will also be understood that embodiments of the present invention are not limited to any particular implementation or programming technique and that the invention may be implemented using any appropriate techniques for implementing the functionality described herein. Furthermore, embodiments are not limited to any particular programming language or operating system.

The methodologies described herein are, in one embodiment, performable by one or more processors that accept computer-readable (also called machine-readable) logic encoded on one or more computer-readable media containing a set of instructions that when executed by one or more of the processors carry out at least one of the methods described herein. Any processor capable of executing a set of instructions (sequential or otherwise) that performs the functions or actions to be taken are contemplated by the present invention. Thus, one example is a typical processing system that includes one or more processors. Each processor may include one or more of a CPU, a graphics processing unit, or a programmable digital signal processing (DSP) unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display or any suitable display for a hand held device. If manual data entry is required, the processing system also includes an input device such as one or more of an alphanumeric input unit such as a keyboard, a pointing control device such as a mouse, stylus, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries logic (e.g., software) including a set of instructions to cause performing, when executed by one or more processors, one of more of the methods described herein. The software may reside in the hard disk, or may also reside, completely or at least partially, within the RAM and/or within the processor during execution thereof by the computer system. Thus, the memory and the processor also constitute computer-readable carrier medium on which is encoded logic, e.g., in the form of instructions.

Thus, one embodiment of each of the methods described herein is in the form of a computer-readable carrier medium carrying a set of instructions, e.g., a computer program that are for execution on one or more processors, e.g., one or more processors that are part of a communication network. Thus, as will be appreciated by those skilled in the art, embodiments of the present invention may be embodied as a method, an apparatus such as a data processing system, or a computer-readable carrier medium, e.g., a computer program product. The computer-readable carrier medium carries logic including a set of instructions that when executed on one or more processors cause the processor or processors to implement a method. Accordingly, the present invention may take the form of a method, an entirely hardware embodiment, an entirely software embodiment or an embodiment combining software and hardware. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, (i) in one set of embodiment, a tangible computer-readable medium, e.g., a solid-state memory, or a computer software product encoded in computer-readable optical or magnetic media; (ii) in a different set of embodiments, a medium bearing a propagated signal detectable by at least one processor of one or more processors and representing a set of instructions that when executed implement a method; (iii) in a different set of embodiments, a carrier wave bearing a propagated signal detectable by at least one processor of the one or more processors and representing the set of instructions a propagated signal and representing the set of instructions; (iv) in a different set of embodiments, a transmission medium in a network bearing a propagated signal detectable by at least one processor of the one or more processors and representing the set of instructions.

In the foregoing specification, specific embodiments of the present invention have been described. However, one of ordinary skill in the art appreciates that various modifications and changes can be made without departing from the scope of the present invention as set forth in the claims below. For example, the therapeutic light source and the massage component are not limited to the presently disclosed forms. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method comprising:
segmenting an audio source file;
optimizing a model based upon probability; and
separating the audio source file.

2. The method of claim 1, wherein the mixture likelihood is driven by a multi-state probabilistic model

3. The method of claim 2 wherein each state probabilistic density is driven by a Gaussian process,

4. The method of claim 3 wherein each state probabilistic density is a Gaussian distribution, observation at time t according to a predetermined equation.

5. The method of claim 1, wherein the segmenting step initializes an optimization algorithm.

6. The method of claim 1, wherein the segmenting step is performed using Vector Quantization.

7. The method of claim 1, wherein the segmenting step finds an optimized state sequence and state Gaussian distribution parameters.

8. The method of claim 1, wherein the segmenting step finds a pair of optimized variables in each state.

9. The method of claim 1, wherein the segmenting step uses an the Expectation Maximization algorithm to find the best state sequence

10. The method of claim 1, wherein the segmenting step uses, in each state, a Non Negative Matrix Factorization algorithm to find the best covariance matrix for the gaussian density associated to the state.

11. The method of claim 1, wherein the segmenting step uses a pair of Viterbi backward/forward equations.

12. The method of claim 1 wherein in the segmenting step each state likelihood is given under an assumption of a Normal distribution with a zero mean and a diagonal covariance matrix given by or according to a predetermined formula.

13. The method of claim 1, wherein the separating step comprises applying a Psuedo Wiener filter.
